(19) United States
(12) Patent Application Publication
(10) Pub. No.: US 2025/0119506 A1
(43) Pub. Date: Apr. 10, 2025

(54) IMAGE-FORMING APPARATUS FOR SUPPRESSING IMAGE UNEVENNESS

(71) Applicant: CANON KABUSHIKI KAISHA, Tokyo (JP)

(72) Inventor: TATSUOMI MURAYAMA, Chiba (JP)

(21) Appl. No.: 18/910,556

(22) Filed: Oct. 9, 2024

(30) Foreign Application Priority Data
Oct. 10, 2023 (JP) 2023-175547

(51) Int. Cl. H04N 1/028; H04N 1/00

(52) U.S. Cl. CPC H04N 1/02885; H04N 1/00031; H04N 1/00082

(57) ABSTRACT

An image-forming apparatus includes image-forming units configured to respectively form images of different colors; an interface for use in instructing the image-forming units to form a test image; and a controller configured to: control the image-forming units to form a first test image including image regions of the colors, the first test image being used for correcting density unevenness in a first direction; and control the image-forming units to form a second test image including image regions of the colors, the second test image being used for correcting density unevenness in a second direction. In a case where the interface receives an instruction to form both of the first test image and the second test image, the controller is configured to control the image-forming units to form the first test image and then form the second test image.

### BACKGROUND

### Field of the Disclosure

The present disclosure relates to an image-forming apparatus for suppressing image unevenness.

### Description of the Related Art

The quality of images formed by an image-forming apparatus based on an electrophotographic method is influenced by a variety of factors, such as fluctuations in temperature and humidity, temporal deterioration of components, and variations in dimension and performance at the time of manufacture. For example, if the sensitivity of a photosensitive member, the amount of exposure laser light, a charging voltage, or a development voltage is uneven, or if an aberration has occurred in a lens of an optical system, density or color unevenness appears in an output image.

Japanese Patent Laid-Open No. 2011-191416 discloses an image-forming apparatus that forms a test pattern including belt-like patterns extending in the main-scanning direction on a sheet, and adjusts an image-forming condition based on a read image obtained by optically reading the formed test pattern, thereby suppressing density unevenness. Japanese Patent No. 3825184 discloses an image-forming apparatus that measures developing agent unevenness on a photosensitive member and adjusts an image-forming condition in accordance with a rotation period of a development roller based on the measurement result in order to reduce periodical density unevenness in the sub-scanning direction, which is attributed to resistance unevenness in the circumferential direction of the development roller.

### SUMMARY

Both of the image-forming apparatus described in Japanese Patent Laid-Open No. 2011-191416 and the image-forming apparatus described in Japanese Patent No. 3825184 only execute calibration for correcting unevenness in one of the directions. Therefore, in order to correct unevenness in both of the main-scanning direction and the sub-scanning direction, it is necessary to execute calibration in one direction after calibration in another direction has been completed; this extends a time period in which a user is tied up in front of the image-forming apparatus.

A technology according to the present disclosure is intended to provide an image-forming apparatus capable of executing an appropriate type of calibration for suppressing image unevenness.

According to one aspect, there is provided an image-forming apparatus including: image-forming units configured to respectively form images of different colors; an interface for use in instructing the image-forming units to form a test image; and a controller configured to: control the image-forming units to form a first test image including a plurality of image regions of the colors, the first test image being used for correcting density unevenness in a first direction in an image to be formed by the image-forming units; and control the image-forming units to form a second test image including a plurality of image regions of the colors, the second test image being used for correcting density unevenness in a second direction that is different from the first direction in an image to be formed by the image-forming units. In a case where the interface receives an instruction to form both of the first test image and the second test image, the controller is configured to control the image-forming units to form the first test image and then form the second test image.

Further features of the present disclosure will become apparent from the following description of exemplary embodiments (with reference to the attached drawings).

### BRIEF DESCRIPTION OF THE DRAWINGS

FIG. 1 is a schematic configuration diagram showing an exemplary configuration of an image-forming apparatus according to one or more aspects of the present disclosure.

FIG. 2 is a block diagram showing an exemplary configuration of a printer controller according to one or more aspects of the present disclosure.

FIG. 3 is a diagram illustrating an exemplary configuration of a first test pattern that is used to measure image unevenness in the main-scanning direction.

FIG. 4 is a diagram illustrating density measurement that is performed for each partial region using a read image of the first test pattern.

FIG. 5 is a graph showing an example of a luminance-density curve.

FIG. 6 is a diagram illustrating an exemplary configuration of a second test pattern that is used to measure image unevenness in the sub-scanning direction.

FIG. 7 is a diagram illustrating density measurement that is performed for each partial region using a read image of the second test pattern.

FIG. 8A is a diagram illustrating a first example of a GUI configuration for causing a user to select a correction mode.

FIG. 8B is a diagram illustrating a second example of a GUI configuration for causing a user to select a correction mode.

FIG. 9 is a flowchart showing an example of a flow of processing executed in a main-scanning correction mode.

FIG. 10 is a flowchart showing an example of a flow of processing executed in a sub-scanning correction mode.

FIG. 11 is a flowchart showing an example of a flow of processing executed in a collective correction mode.

FIG. 12 is a flowchart showing an example of a flow of exposure control processing at the time of execution of an image-forming job.

FIG. 13 is a schematic configuration diagram showing an exemplary configuration of an image-forming apparatus according to a first modification example.

FIG. 14 is a flowchart showing an example of a flow of processing executed in a sub-scanning correction mode according to the first modification example.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### <1. Exemplary Configuration of Image-Forming Apparatus>

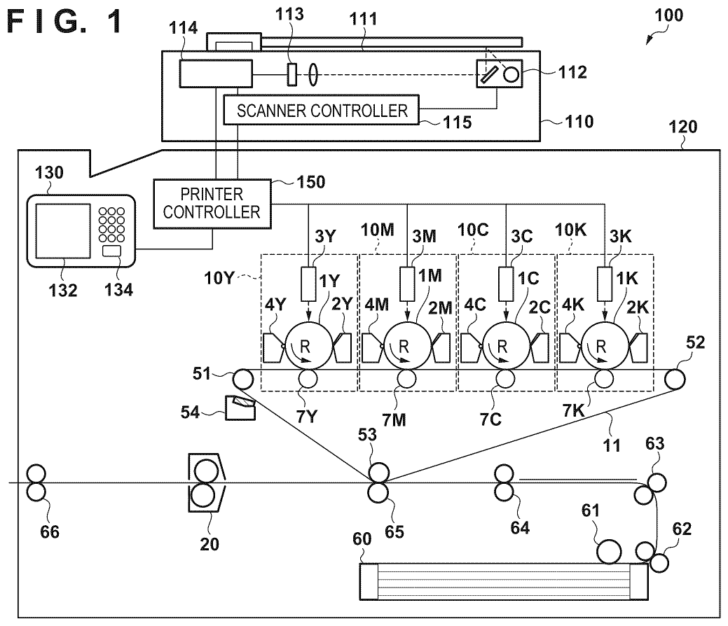

FIG. 1 is a schematic configuration diagram showing an exemplary configuration of an image-forming apparatus 100 according to an embodiment. The present specification will mainly describe an example in which the image-forming apparatus 100 is a digital multi-functional peripheral. However, a technology according to the present disclosure is not limited to this example, and is also applicable to any type of image-forming apparatus, such as a copy machine, a printer, and a facsimile machine.

Referring to FIG. 1, the image-forming apparatus 100 includes a scanner unit 110, a printer unit 120, and an operation unit 130. The scanner unit 110 optically reads a document, and generates read image data. The printer unit 120 forms an image on a sheet (also referred to as a recording material) based on, for example, read image data generated by the scanner unit 110, or image data for printing received from an external apparatus (not shown) via a network. The operation unit 130 provides an interface for interaction between the image-forming apparatus 100 and a user.

### (1) Printer Unit

The printer unit 120 includes image-forming units 10Y, 10M, 10C, and 10K. The image-forming units 10Y, 10M, 10C, and 10K form toner images (developing agent images) in yellow (Y), magenta (M), cyan (C), and black (K), respectively. The image-forming units 10Y, 10M, 10C, and 10K may be configured in the same manner. Therefore, in the following description, the alphabetical character at the end of a reference sign indicating a color component is omitted, and accordingly, the image-forming units 10Y, 10M, 10C, and 10K will be collectively referred to as image-forming units 10. The same goes for the reference signs of constituent elements inside the image-forming units 10.

A photosensitive member 1 is an image carrier (e.g., an aluminum cylinder) that is driven to rotate around a rotation axis (counterclockwise in the figure). A charger 2 is a charging unit to which a charging voltage (e.g., a negative-polarity bias voltage) is applied, and which charges a photosensitive layer on the surface of the photosensitive member 1 at a uniform, negative-polarity potential. An exposure device 3 is an exposure unit that includes a light source and exposes the charged surface of the photosensitive member 1 to light from the light source, thereby forming an electrostatic latent image on the surface of the photosensitive member 1. The exposure device 3 may be, for example, a laser scanner, and writes each line of the latent image on the surface of the photosensitive member 1 by emitting laser light in accordance with input image data input from a printer controller 150 while scanning the surface of the photosensitive member 1 in a first direction parallel to the rotation axis of the photosensitive member 1. In the following description, the first direction parallel to the rotation axis of the photosensitive member 1 and a second direction perpendicular to the first direction (parallel to the sheet conveyance direction) are also referred to as a main-scanning direction and a sub-scanning direction, respectively. A developer 4 is a developing unit that forms a toner image by developing the electrostatic latent image on the surface of the photosensitive member 1 using toner, which acts as a developing agent. The toner image is carried by the photosensitive member 1, and conveyed to a primary transfer position at which the photosensitive member 1 comes into contact with an intermediate transfer belt 11. A primary transfer roller 7 receives a primary transfer voltage (e.g., a positive-polarity bias voltage) applied thereto, and transfers the toner image on the surface of the photosensitive member 1 to the intermediate transfer belt 11. Toner images on the four photosensitive members 1 are transferred to the intermediate transfer belt 11 in such a manner that they overlap one another; as a result, a color image including four color components, namely yellow, magenta, cyan, and black, is formed on the intermediate transfer belt 11.

The intermediate transfer belt 11 is hung in a stretched state on a tension roller 51, a driving roller 52, and an opposing roller 53. The intermediate transfer belt 11 rotates clockwise in the figure in accordance with rotation of the driving roller 52, thereby conveying the toner images to a transfer nip between the opposing roller 53 and a secondary transfer roller 65.

A cassette 60 houses a stack of sheets. A pickup roller 61 picks up a sheet from the cassette 60, and feeds the sheet to a conveyance path. A separation roller 62 separates the sheet from the stack of sheets. A conveyance roller 63 conveys the separated sheet to a registration roller 64 along the conveyance path. The registration roller 64 sends the conveyed sheet to the transfer nip in harmony with a timing at which the toner images on the intermediate transfer belt 11 arrive at the transfer nip. The secondary transfer roller 65 receives a secondary transfer voltage applied thereto, transfers the toner images on the intermediate transfer belt 11 to the sheet using the secondary transfer voltage, and conveys the sheet to a fixing device 20 that is located further downstream. A belt cleaner 54 collects toner that remains on the intermediate transfer belt 11 after passing through the transfer nip.

The fixing device 20 applies heat and pressure to the sheet to which the toner images have been transferred, thereby fixing the toner images on the sheet. After the toner images have been fixed, a discharge roller 66 discharges the sheet to the outside of the image-forming apparatus 100.

The printer controller 150 controls overall operations of the printer unit 120, including the above-described image-forming units 10Y, 10M, 10C, and 10K. Especially, an exemplary configuration of the printer controller 150 related to measurement and correction of image unevenness will be described below in detail.

Note that although the above has described an example in which a toner image is transferred indirectly from each photosensitive member 1 to a sheet via the intermediate transfer belt 11, the toner image may be transferred directly from each photosensitive member 1 to the sheet. Furthermore, although the above has described an example in which a color image is formed using toner in a plurality of colors, a technology according to the present disclosure is also applicable to an image-forming apparatus that forms a monochrome image using toner in a single color.

### (2) Scanner Unit

The scanner unit 110 includes a document tray 111, a light emission unit 112, an image sensor 113, an image processing circuit 114, and a scanner controller 115. The light emission unit 112 irradiates a lower surface of a document placed on the document tray 111 with light while moving in the left-right direction in the figure. The light that has reflected off the lower surface of the document is guided via an optical system, which can include a mirror, a lens, and the like, and an image of the light is formed on an image plane of the image sensor 113. The image sensor 113 generates read image data by optically reading the lower surface of the document, and outputs the generated read image data to the image processing circuit 114. The image processing circuit 114 executes such image processing as noise removal and resolution conversion with respect to the read image data. The scanner controller 115 controls the aforementioned operations of the scanner unit 110.

Note that although the above has described an example in which the scanner unit 110 reads a document placed on the document tray 111, a technology according to the present disclosure is not limited to this example. For example, the scanner unit 110 may include an auto-document feeder (ADF) function and be capable of reading a document conveyed along a conveyance path.

### (3) Operation Unit

The operation unit 130 includes a display 132 and an input device 134. As will be described below, the display 132 displays a graphical user interface (GUI) generated by the printer controller 150. The input device 134 may include, for example, one or more buttons, key pads, and switches, and accept an operational input from a user. Note that the display 132 and the input device 134 may be configured integrally as a touch panel.

### <2. Exemplary Configuration of Printer Controller>

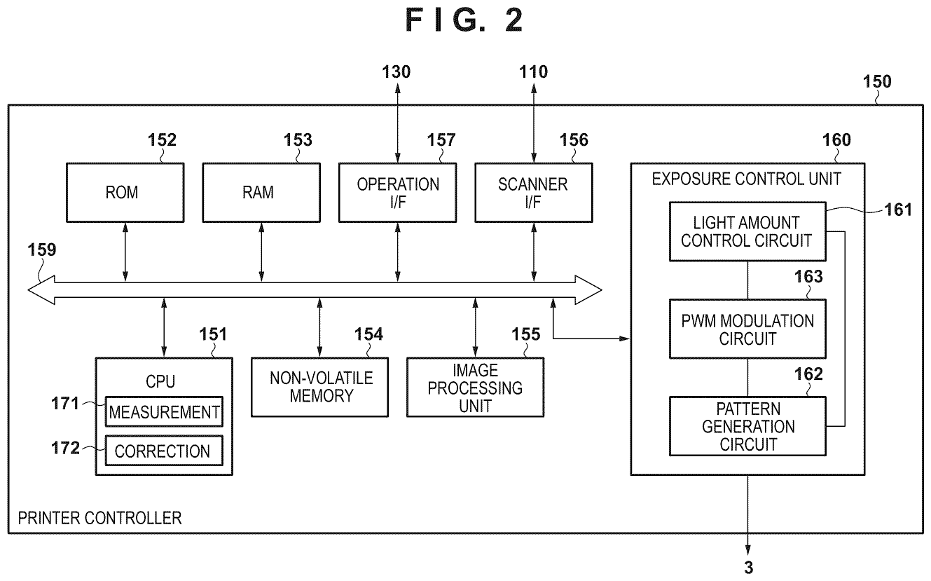

FIG. 2 is a block diagram showing an exemplary configuration of the printer controller 150 according to an embodiment. This figure only shows constituent elements that are mainly related to measurement and correction of unevenness, and other constituent elements that can be included in the printer controller 150 are omitted therein. Referring to FIG. 2, the printer controller 150 includes a CPU 151, a ROM 152, a RAM 153, a nonvolatile memory 154, an image processing unit 155, a scanner interface (I/F) 156, an operation I/F 157, a bus 159, and an exposure control unit 160.

The central processing unit (CPU) 151 is a processor that controls overall functions of the printer controller 150. A computer program to be executed by the CPU 151 is stored in the read-only memory (ROM) 152 in advance. The random access memory (RAM) 153 provides a temporary storage area for computation to the CPU 151. The nonvolatile memory 154 is a storage unit that stores various types of data that can be referred to or updated by the CPU 151. The image processing unit 155 executes various types of image processing with respect to input image data of an image-forming job (e.g., a copy job or a print job) executed by the printer unit 120. Image processing executed by the image processing unit 155 can include, for example, rasterization, color conversion, resolution conversion, and binarization. The scanner I/F 156 is an interface for connecting the printer controller 150 to the scanner unit 110. The operation I/F 157 is an interface for connecting the printer controller 150 to the operation unit 130.

The exposure control unit 160 controls exposure of the photosensitive member 1 to light, which is performed by the exposure device 3 of each image-forming unit 10. In the present embodiment, the exposure control unit 160 has a so-called shading function, and can perform variable control on the light amount of laser light emitted from the exposure device 3 (also referred to as laser power (LPW)) during a scanning period for one line in the main-scanning direction. Referring to FIG. 2, the exposure control unit 160 includes a light amount control circuit 161, a PWM modulation circuit 162, and a pattern generation circuit 163.

When an image-forming job is executed, the light amount control circuit 161 performs variable control on the light amount of laser light emitted from the exposure device 3 of each image-forming unit 10 so that image unevenness is suppressed in both of the main-scanning direction and the sub-scanning direction. For example, the nonvolatile memory 154 stores initial profile data indicating the result of measurement of image unevenness attributed to a manufacturing error, and/or profile data that has been updated through below-described correction processing. Profile data may indicate, for example, the amount of correction of a light amount for cancelling out unevenness (making the density even among partial regions), which is determined for each partial region in an image. The light amount control circuit 161 calculates a desired light amount for each partial region by adding a correction amount indicated by the profile data to a reference value, and issues an instruction indicating a value of the calculated light amount to the PWM modulation circuit 162. The PWM modulation circuit 162 performs pulse-width modulation (PWM) on a driving signal (pulse signal) output to the exposure device 3 in accordance with the value of the light amount indicated by the light amount control circuit 161. Specifically, for a pixel for which the input image data indicates light-emission ON, the PWM modulation circuit 162 supplies, to the exposure device 3, a pulse signal with a duty cycle corresponding to a value of the light amount indicated by the light amount control circuit 161. Conversion from the value of the light amount into a duty cycle can be performed using, for example, a lookup table (LUT) that has been determined and stored into the memory in advance. When this conversion is performed, gradation correction, such as y correction for example, may be performed based on the relationship between a laser output level and an image density. When a certain pixel is exposed to light, the larger the duty cycle of the laser light, the longer the exposure time period, and the larger the size of dots that are formed. If the size of dots formed in a certain partial region is large, the area gradation, that is to say, the image density in this partial region becomes high. When the exposure device 3 exposes the photosensitive member 1 to light through the aforementioned exposure control, a latent image representing an image corresponding to the input image data is formed on the surface of the photosensitive member 1 while unevenness is suppressed.

The size of the aforementioned partial region may be any size dependent on the resolution of required correction. For example, in a case where the maximum width of an image that can be formed by the image-forming apparatus 100 in the main-scanning direction is approximately 330.2 mm, this maximum width may be divided into 14 partial regions, thereby setting the size of the partial region in the main-scanning direction at approximately 23.59 mm. Also, in a case where the length of the outer circumference of the photosensitive member 1 in the sub-scanning direction is 300 mm, this length may be divided into 10 partial regions, thereby setting the size of the partial region in the sub-scanning direction at approximately 30.0 mm.

### <3. Measurement of Unevenness and Calculation of Correction Amount>

Unevenness in an image formed by the image-forming apparatus 100 can occur due to not only a manufacturing error, but also fluctuations in environmental factors and temporal deterioration of components. In order to capture and suppress such unevenness with high accuracy, the printer controller 150 has a measurement function of measuring unevenness, and a correction function of correcting an operation condition (hereinafter referred to as an image-forming condition) of the image-forming units 10 based on the result of measurement of unevenness. Specifically, in the present embodiment, the CPU 151 functions as a measurement unit 171 and a correction unit 172.

The measurement unit 171 can measure image unevenness in the main-scanning direction and the sub-scanning direction. The correction unit 172 corrects the image-forming condition of the image-forming units 10 based on the result of measurement performed by the measurement unit 171. In the present embodiment, the image-forming condition corrected by the correction unit 172 includes the light amount of laser light emitted by the exposure devices 3. In another embodiment, the image-forming condition corrected by the correction unit 172 may include other conditions, such as a charging voltage, a development voltage, a transfer voltage, and the like.

In the present embodiment, the measurement of image unevenness in the main-scanning direction and the measurement of image unevenness in the sub-scanning direction are both performed by optically reading images of test patterns formed on sheets.

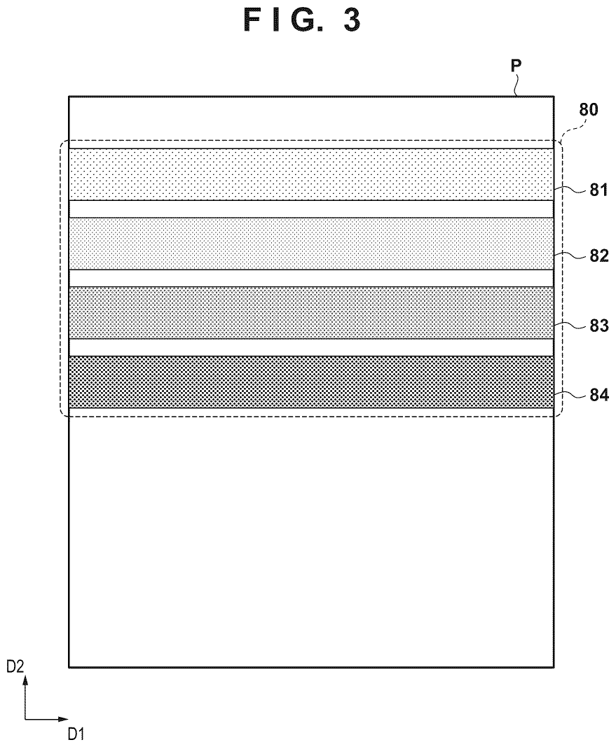

FIG. 3 is a diagram illustrating an exemplary configuration of a first test pattern 80 that is used to measure image unevenness in the main-scanning direction. The first test pattern 80 includes four rectangular regions 81, 82, 83, and 84 that respectively correspond to the four color components, namely C, M, Y, and K. Each of the rectangular regions 81, 82, 83, and 84 is a belt-like image region that extends across the entire width of a sheet P in the main-scanning direction D1, and occupies a certain length in the sub-scanning direction D2. Thus, the longitudinal direction of each of the rectangular regions 81, 82, 83, and 84 is the main-scanning direction D1. The rectangular region 81 is uniformly formed by the image-forming unit 10C using, for example, a cyan signal value of 40%. The rectangular region 82 is uniformly formed by the image-forming unit 10M using, for example, a magenta signal value of 40%. The rectangular region 83 is uniformly formed by the image-forming unit 10Y using, for example, a yellow signal value of 40%. The rectangular region 84 is uniformly formed by the image-forming unit 10K using, for example, a black signal value of 40%.

The pattern generation circuit 163 of the exposure control unit 160 stores the configuration of the first test pattern 80, which is defined in advance. In response to an instruction from the measurement unit 171, the pattern generation circuit 163 controls the image-forming units 10Y, 10M, 10C, and 10K to form the image of the first test pattern 80 on the sheet P. Once the image of the first test pattern 80 has been formed on the sheet P, a user sets the sheet P on the scanner unit 110, and causes the image of the first test pattern 80 to be read. The scanner unit 110 generates a read image of the first test pattern 80 by optically reading the image of the first test pattern 80 on the sheet P, and outputs read image data to the measurement unit 171.

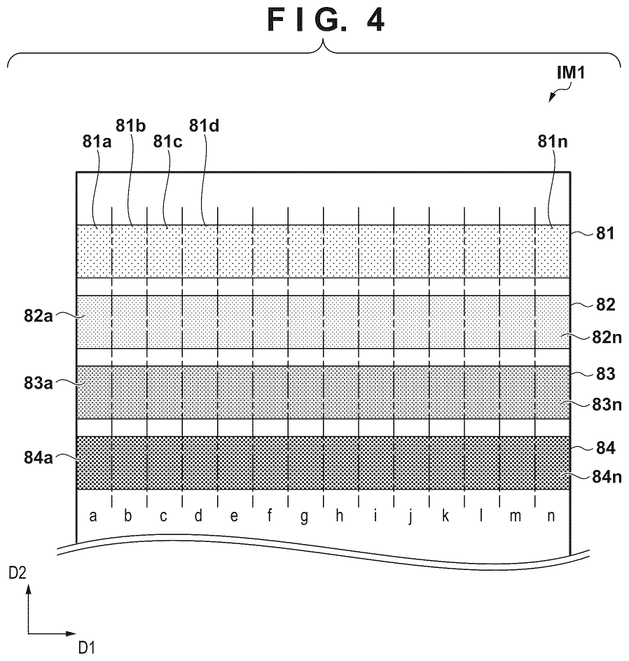

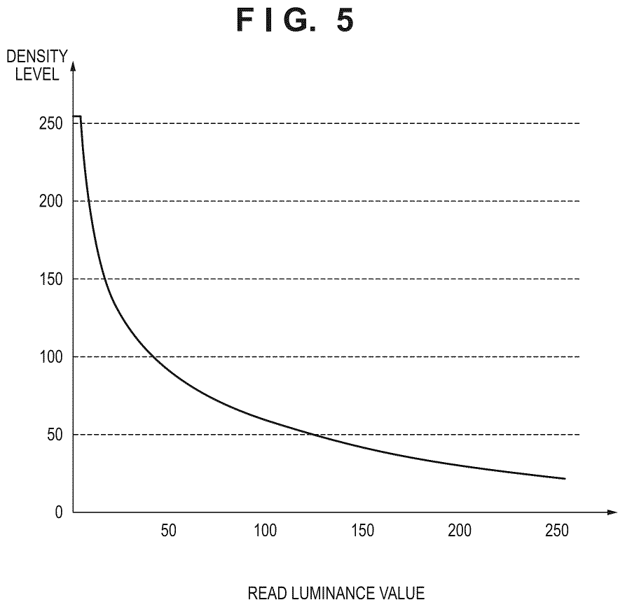

FIG. 4 is a diagram illustrating density measurement that is performed for each partial region using a read image IM1 of the first test pattern 80. Referring to FIG. 4, in the read image IM1, the rectangular region 81 is divided into 14 partial regions 81a to 81n in the main-scanning direction D1. The measurement unit 171 calculates an average luminance value for each of these partial regions 81a to 81n, and further converts the average luminance value into a cyan density level. A graph of FIG. 5 shows an example of a luminance-density curve indicating the relationship between a luminance value in the read image (a read luminance value) and a density level. In the graph, the horizontal axis represents the read luminance value, the vertical axis represents the density level, and the ranges of the read luminance value and the density level are both 0 to 255. Such a luminance-density curve has been determined in advance for each color component and stored in the nonvolatile memory 154 in the form of an LUT, for example. Using the luminance-density curve (or the corresponding LUT), the measurement unit 171 converts the average luminance value of each of the partial regions 81a to 81n into a density level. Furthermore, the measurement unit 171 calculates a difference (hereinafter referred to as a density difference) between a reference value (e.g., an average density level throughout the entire rectangular region 81, or a target value of a density level) and the density level for each of the partial regions 81a to 81n. The density differences that are calculated for the respective partial regions in the above-described manner indicate image unevenness in the main-scanning direction D1 (for the cyan component in this case). With respect to other color components, too, the measurement unit 171 similarly measures image unevenness in the main-scanning direction D1 using the read luminance values of partial regions 82a to 82n of the rectangular region 82, partial regions 83a to 83n of the rectangular region 83, and partial regions 84a to 84n of the rectangular region 84.

The correction unit 172 converts the density differences of the respective partial regions of each color component, which have been calculated by the measurement unit 171, into the amounts of light amount correction. For example, assume that the indices of partial regions aligned in the main-scanning direction D1 are x (x∈{a, b, . . . , n}), the indices of color components are c (c∈{Y, M, C, K}), and the density difference in the partial region x of the color component c is Δd_{c,x}. Then, the density difference Δd_{c,x} can be converted into a correction amount ΔL_{c,x} in accordance with the following formula.

$$Δ {L}_{c , x} = round ( Δ {d}_{c , x} \times {N}_{c} ) \qquad ( 1 )$$

Here, Ne is a conversion coefficient that influences the extent to which the light amount of laser light of the color component c (the pulse width or duty cycle of the driving signal, or laser power) is to be changed relative to the density fluctuation. round ( ) denotes a function that rounds off an argument. The value of the conversion coefficient Ne can be determined in advance and stored in the nonvolatile memory 154. As an example, a common conversion coefficient N_{c}=200 may be used for the plurality of color components; in this case, when the density difference Δd_{c,x}=0.01, the correction amount ΔL_{c,x}=2. Note that the method of converting the density difference into the correction amount is not limited to the method that uses formula (1). For example, a linear or nonlinear conversion formula different from formula (1) may be adopted, or a conversion method that uses a lookup table may be adopted. Also, in calculating the density difference of each partial region, a median of luminance values or some other statistical values may be used in place of the average luminance value of each partial region.

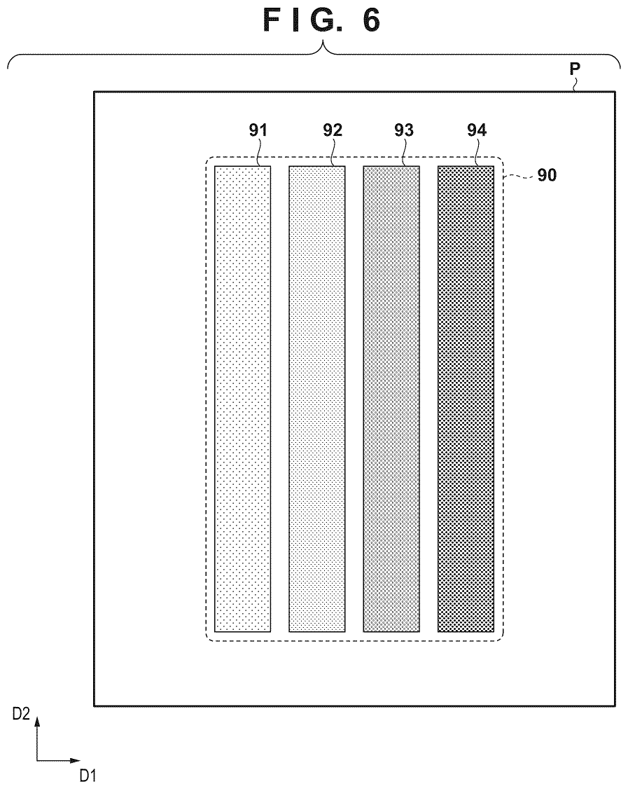

FIG. 6 is a diagram illustrating an exemplary configuration of a second test pattern 90 that is used to measure image unevenness in the sub-scanning direction. The second test pattern 90 includes four rectangular regions 91, 92, 93, and 94 that respectively correspond to the four color components, namely C, M, Y, and K. Each of the rectangular regions 91, 92, 93, and 94 is an image region that occupies a certain width in the main-scanning direction D1, and extends in the sub-scanning direction D2 over a certain length. The length of each rectangular region in the sub-scanning direction D2 is equivalent to the length of the outer circumference of the photosensitive member 1. The rectangular region 91 is uniformly formed by the image-forming unit 10C using, for example, a cyan signal value of 40%. The rectangular region 92 is uniformly formed by the image-forming unit 10M using, for example, a magenta signal value of 40%. The rectangular region 93 is uniformly formed by the image-forming unit 10Y using, for example, a yellow signal value of 40%. The rectangular region 94 is uniformly formed by the image-forming unit 10K using, for example, a black signal value of 40%.

The pattern generation circuit 163 of the exposure control unit 160 stores the configuration of the second test pattern 90, which is defined in advance. In response to an instruction from the measurement unit 171, the pattern generation circuit 163 controls the image-forming units 10Y, 10M, 10C, and 10K to form the image of the second test pattern 90 on a sheet P. At this time, positioning is performed so that the home position of the angle of rotation of the photosensitive member 1 matches the line at which writing of the second test pattern 90 is started, in order to prevent a displacement in the correspondence relationship between the phase of rotation of the photosensitive member 1 and the position of the second test pattern 90 in the sub-scanning direction D2. Once the image of the second test pattern 90 has been formed on the sheet P, the user sets the sheet P on the scanner unit 110, and causes the image of the second test pattern 90 to be read. The scanner unit 110 generates a read image of the second test pattern 90 by optically reading the image of the second test pattern 90 on the sheet P, and outputs read image data to the measurement unit 171.

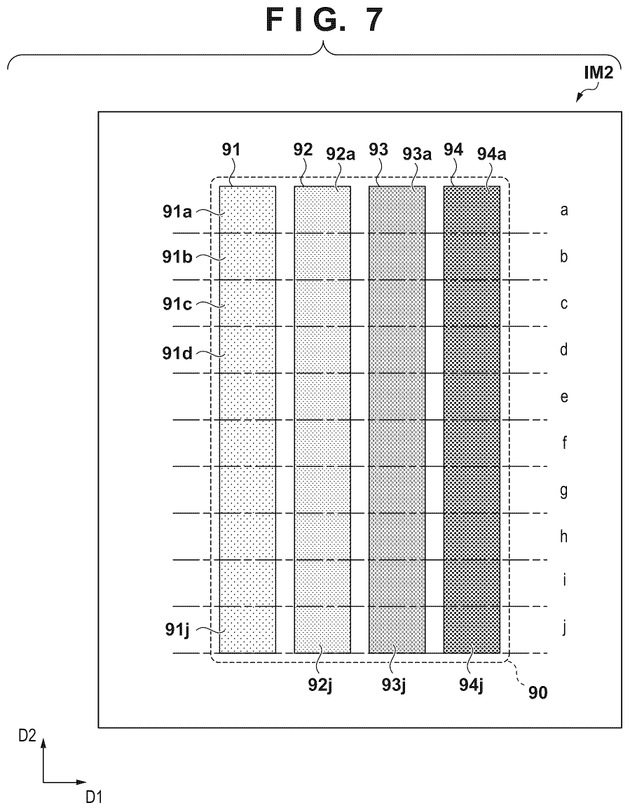

FIG. 7 is a diagram illustrating density measurement that is performed for each partial region using a read image IM2 of the second test pattern 90. Referring to FIG. 7, in the read image IM2, the rectangular region 91 is divided into 10 partial regions 91a to 91j in the sub-scanning direction D2. The measurement unit 171 calculates an average luminance value for each of these partial regions 91a to 91j, and converts the average luminance value into a cyan density level using, for example, the method that has been described in relation to FIG. 5. Furthermore, the measurement unit 171 calculates a density difference from a reference value for each of the partial regions 91a to 91j. The density differences that are calculated for the respective partial regions in the above-described manner indicate image unevenness in the sub-scanning direction D2 (for the cyan component in this case). With respect to other color components, too, the measurement unit 171 similarly measures image unevenness in the sub-scanning direction D2 using the read luminance values of the partial regions 92a to 92j of the rectangular region 92, the partial regions 93a to 93j of the rectangular region 93, and the partial regions 94a to 94j of the rectangular region 94.

With respect to the sub-scanning direction D2, too, the correction unit 172 converts the density differences of the respective partial regions of each color component, which have been calculated by the measurement unit 171, into the correction amounts of light amount, similarly to the main-scanning direction D1. For example, assume that the indices of partial regions aligned in the sub-scanning direction D2 are y (y∈{a, b, . . . , j}), the indices of color components are c (c∈{Y, M, C, K}), and the density difference in the partial region y of the color component c is Δd_{e,y}. Then, the density difference Δd_{c,y} can be converted into a correction amount ΔL_{c,y} in accordance with the following formula.

$$Δ {L}_{c , y} = round ( Δ {d}_{c , y} \times {N}_{c} ) \qquad ( 2 )$$

Note that, once again, the method of converting the density difference into the correction amount is not limited to the method that uses formula (2).

Regarding the correction amount that is used by the light amount control circuit 161 in controlling the light amount for each partial region in an input image, provided that an individual partial region is identified by indices x and y and this correction amount is ΔL_{c,x,y}, this correction amount can be the sum of the correction amounts ΔL_{c,x} and ΔL_{c,y} in the main-scanning direction and the sub-scanning direction as indicated by the following formula.

$$Δ {L}_{c , x , y} = Δ {L}_{c , x} + Δ {L}_{c , y} \qquad ( 3 )$$

In formula (3), the index x indicates the position of the partial region in the main-scanning direction D1, and the index y indicates the phase of the partial region in the sub-scanning direction D2 (relative to rotation of the photosensitive member 1). Furthermore, the light amount that is used in exposure for each partial region (e.g., the value of the light amount that is indicated to the PWM modulation circuit 162) may be the sum of a reference light amount that is commonly set in advance and the correction amount ΔL_{c,x,y}.

For example, initial profile data indicating the result of measurement of image unevenness attributed to a manufacturing error (the result that has been measured in a factory) is stored in advance in the nonvolatile memory 154. The initial profile data typically includes the following two types of data:
first initial profile data that indicates, for each color component, the result of measurement of image unevenness in the main-scanning direction (e.g., the correction amounts for the respective 14 partial regions aligned in the main-scanning direction) at the manufacturing stage of the image-forming apparatus 100; and
second initial profile data that indicates, for each color component, the result of measurement of image unevenness in the sub-scanning direction (e.g., the correction amounts for the respective 10 partial regions aligned in the sub-scanning direction) at the manufacturing stage of the image-forming apparatus 100.

Furthermore, the nonvolatile memory 154 stores profile data that indicates the latest measurement result in relation to the measurement of image unevenness performed by the measurement unit 171. The profile data typically includes the following two types of data:
first profile data that indicates, for each color component, the latest result of measurement of image unevenness in the main-scanning direction (e.g., the correction amounts for the respective 14 partial regions aligned in the main-scanning direction); and
second profile data that indicates, for each color component, the latest result of measurement of image unevenness in the sub-scanning direction (e.g., the correction amounts for the respective 10 partial regions aligned in the sub-scanning direction).

Each time the measurement unit 171 performs the measurement, the correction unit 172 updates the profile data stored in the nonvolatile memory 154 using the latest measurement result.

### <4. Collective Correction Mode and Separate Correction Mode>

As described above, unevenness in the main-scanning direction and unevenness in the sub-scanning direction are measured using different test patterns. When these measurements can be executed by calling up a function once, the user's effort can be reduced; however, measuring unevenness in both directions at all times actually lowers efficiency timewise. For example, if the user who has viewed a printed image has determined that only unevenness in the sub-scanning direction has room for improvement, they may wish to re-execute the measurement of unevenness only in the sub-scanning direction, and vice-versa.

In the present embodiment, the image-forming apparatus 100 provides a collective correction mode and a separate correction mode in order to improve efficiency in relation to the execution of a function for suppressing image unevenness while satisfying such needs. In the collective correction mode (first correction mode), the measurement unit 171 measures image unevenness in both of the main-scanning direction and the sub-scanning direction, and the correction unit 172 corrects the image-forming condition of the image-forming units 10 based on the measurement results in the main-scanning direction and the sub-scanning direction. In the separate correction mode (second correction mode), the measurement unit 171 measures image unevenness in one of the main-scanning direction and the sub-scanning direction, and the correction unit 172 corrects the image-forming condition of the image-forming units 10 based on the measurement result in this one direction.

Typically, the separate correction mode is further divided into two correction modes. One is a main-scanning correction mode in which image unevenness is measured only in the main-scanning direction. The other is a sub-scanning correction mode in which image unevenness is measured only in the sub-scanning direction. In the present embodiment, the operation unit 130 provides the user with a graphical user interface (GUI) for use in instructing the image-forming units 10Y, 10M, 10C to form a test image. The GUI allows one of the collective correction mode, the main-scanning correction mode, and the sub-scanning correction mode to be selected. The correction unit 172 corrects the image-forming condition of the image-forming units 10 in the correction mode that has been selected by the user via this GUI.

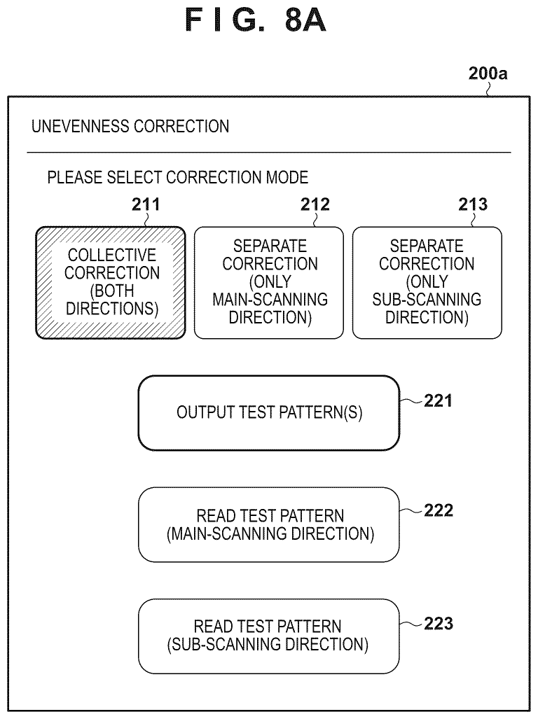

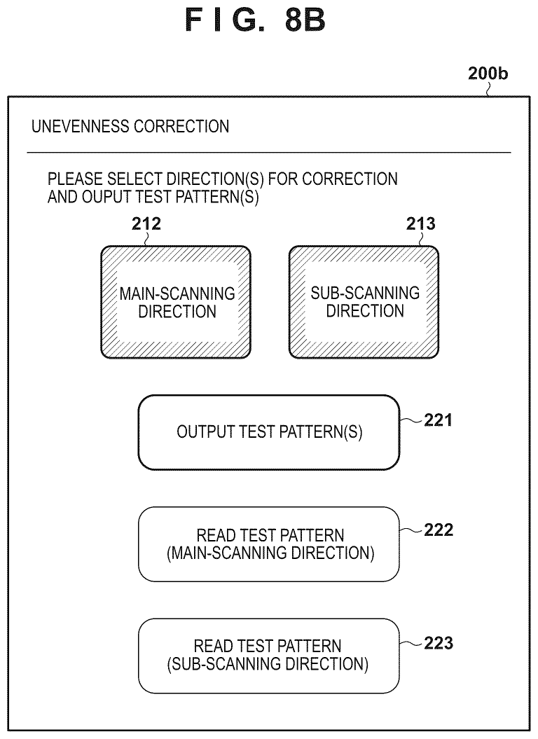

FIG. 8A is a diagram illustrating a first example of a GUI configuration for causing the user to select a correction mode. An unevenness correction screen 200a shown in FIG. 8A is, for example, generated by the measurement unit 171 and displayed on the display 132 of the operation unit 130. Alternatively, the unevenness correction screen 200a may be displayed on a display of a user terminal connected to the image-forming apparatus 100 via a communication I/F that is not shown in FIG. 2. The unevenness correction screen 200a includes three mode selection buttons 211, 212, and 213, a pattern output button 221, and two read buttons 222 and 223.

The mode selection button 211 is a button for selecting the collective correction mode. The mode selection button 212 is a button for selecting the main-scanning correction mode. The mode selection button 213 is a button for selecting the sub-scanning correction mode. In other words, the mode selection button 211 is a first button associated with formation of the first test image. A first instruction to form the first test image is received at least via an operation of the mode selection button 211. The mode selection button 212 is a second button associated with formation of the second test image. A second instruction to form the second test image is received at least via an operation of the mode selection button 212. The mode selection button 213 is a third button associated with formation of the first and second test images. A third instruction to form both of the first and second test images is received at least via an operation of the mode selection button 213.

When one of the correction modes has been selected by the user, the pattern output button 221 is enabled. The pattern output button 221 is a button for starting outputting of one or more test pattern images corresponding to the selected correction mode. When the pattern output button 221 has been operated in a state where the collective correction mode has been selected, the image-forming units 10Y to 10K form an image of the first test pattern on a first sheet, and then an image of the second test pattern on a second sheet, under control of the printer controller 150. When the pattern output button 221 has been operated in a state where the main-scanning correction mode has been selected, the image-forming units 10Y to 10K form the image of the first test pattern on a sheet under control of the printer controller 150. When the pattern output button 221 has been operated in a state where the sub-scanning correction mode has been selected, the image-forming units 10Y to 10K form the image of the second test pattern on a sheet under control of the printer controller 150.

Once the formation of the test pattern image(s) has been completed, one or both of the read buttons 222 and 223 are enabled. In the collective correction mode or the main-scanning correction mode, when the user has operated the read button 222 after setting a sheet on the document tray 111, reading of the image of the first test pattern is started, and the measurement of unevenness and the calculation of correction amounts are performed in the main-scanning direction. In the collective correction mode or the sub-scanning correction mode, when the user has operated the read button 223 after setting a sheet on the document tray 111, reading of the image of the second test pattern is started, and the measurement of unevenness and the calculation of correction amounts are performed in the sub-scanning direction.

FIG. 8B is a diagram illustrating a second example of a GUI configuration for causing the user to select a correction mode. An unevenness correction screen 200b shown in FIG. 8B may be used instead of the aforementioned unevenness correction screen 200a. The unevenness correction screen 200b includes two mode selection buttons 212 and 213, a pattern output button 221, and two read buttons 222 and 223.

Similarly to the first example, the mode selection button 212 is a button for selecting the main-scanning correction mode, and the mode selection button 213 is a button for selecting the sub-scanning correction mode. However, according to the second example, the user is allowed to select the collective correction mode by operating both of the mode selection buttons 212 and 213. The mode selection button 213 illustrated in FIG. 8A is omitted in this second example. The first instruction to form the first test image is received via operations of the mode selection button 212 and the pattern output button 221. The pattern output button 221 is a fourth button for triggering formation of a test image. The second instruction to form the second test image is received via operations of the mode selection button 213 and the pattern output button 221. The third instruction to form both of the first and second test images is received via operations of the mode selection buttons 212 and 213, and the pattern output button 221. For example, when the pattern output button 221 has been operated in a state where both of the mode selection buttons 212 and 213 have been selected as shown in FIG. 8B, outputting of the images of the two test patterns corresponding to the collective correction mode is started. In this case, the image-forming units 10Y to 10K form the image of the first test pattern on a first sheet, and then the image of the second test pattern on a second sheet.

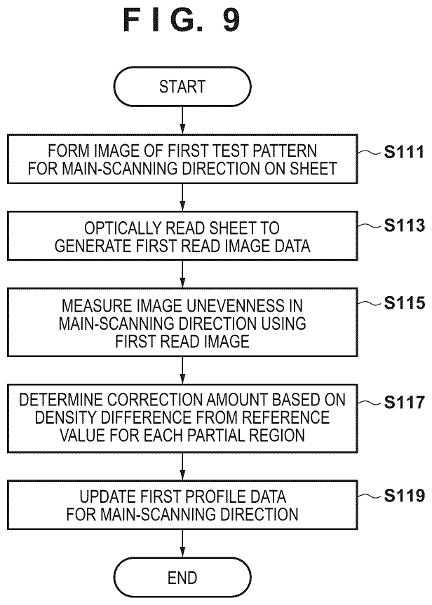

The following describes flows of processing in the main-scanning correction mode, the sub-scanning correction mode, and the collective correction mode with use of FIG. 9 to FIG. 11. In each flowchart, processing steps are abbreviated as “S”.

### (1) Main-Scanning Correction Mode

FIG. 9 is a flowchart showing an example of a flow of processing executed by the printer controller 150 in the main-scanning correction mode.

In the main-scanning correction mode, first, the image-forming units 10Y to 10K form the image of the first test pattern generated by the pattern generation circuit 163 on a sheet in response to an operation on the pattern output button 221 in step S111.

Next, in step S113, the scanner unit 110 generates a first read image by optically reading the sheet on which the first test pattern has been formed in response to an operation on the read button 222. The scanner controller 115 outputs read image data indicating the first read image to the printer controller 150.

Next, in step S115, the measurement unit 171 measures image unevenness in the main-scanning direction using the first read image. More specifically, for each of the plurality of partial regions aligned in the main-scanning direction, the measurement unit 171 calculates an average luminance value of the first read image, converts the calculated average luminance value into a density level, and calculates a difference between the density level and the reference value (i.e., a density difference).

Next, in step S117, the correction unit 172 determines the correction amounts for the respective partial regions based on the density differences in the respective partial regions calculated by the measurement unit 171. Note that although the details are not shown in FIG. 9 for the sake of simple explanation, the measurement of unevenness in step S115 and the determination of the correction amounts for the respective partial regions in step S117 can be repeated for each of the four color components.

Next, in step S119, the correction unit 172 updates the first profile data stored in the nonvolatile memory 154 so that it reflects the correction amounts determined in step S117. Then, the processing of FIG. 9 is ended.

As can be understood from FIG. 9, in the main-scanning correction mode, image unevenness in the sub-scanning direction is not measured, and only image unevenness in the main-scanning direction is newly measured. In a case where the correction has been made in the main-scanning correction mode, when executing a job after the correction, the image-forming units 10Y to 10K form images under the image-forming condition that has been corrected based on the latest measurement result in the main-scanning direction and on the past measurement result in the sub-scanning direction indicated by the second profile data. When the measurement in the sub-scanning direction has not been executed, the second initial profile data indicating the measurement result in the sub-scanning direction at the manufacturing stage of the apparatus can be used instead of the second profile data.

### (2) Sub-Scanning Correction Mode

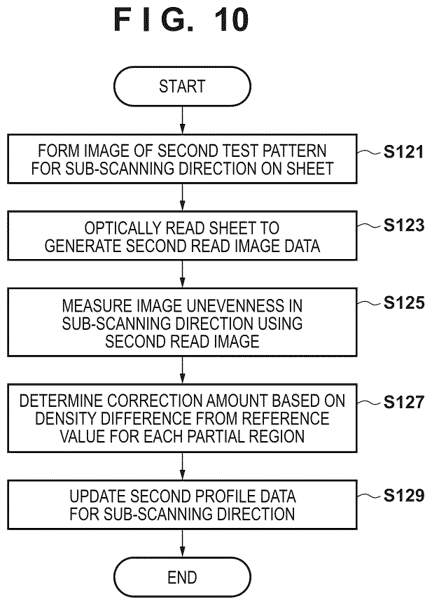

FIG. 10 is a flowchart showing an example of a flow of processing executed by the printer controller 150 in the sub-scanning correction mode.

In the sub-scanning correction mode, first, the image-forming units 10Y to 10K form the image of the second test pattern generated by the pattern generation circuit 163 on a sheet in response to an operation on the pattern output button 221 in step S121. At this time, the image-forming units 10Y to 10K perform positioning so that each of the home positions of the angles of rotation of the photosensitive members 1Y to 1K matches the line at which writing of the second test pattern 90 is started.

Next, in step S123, the scanner unit 110 generates a second read image by optically reading the sheet on which the second test pattern has been formed in response to an operation on the read button 223. The scanner controller 115 outputs read image data indicating the second read image to the printer controller 150.

Next, in step S125, the measurement unit 171 measures image unevenness in the sub-scanning direction using the second read image. More specifically, for each of the plurality of partial regions aligned in the sub-scanning direction, the measurement unit 171 calculates an average luminance value of the second read image, converts the calculated average luminance value into a density level, and calculates a difference between the density level and the reference value (i.e., a density difference).

Next, in step S127, the correction unit 172 determines the correction amounts for the respective partial regions based on the density differences in the respective partial regions calculated by the measurement unit 171. Note that although the details are not shown in FIG. 10 for the sake of simple explanation, the measurement of unevenness in step S125 and the determination of the correction amounts for the respective partial regions in step S127 can be repeated for each of the four color components.

Next, in step S129, the correction unit 172 updates the second profile data stored in the nonvolatile memory 154 so that it reflects the correction amounts determined in step S127. Then, the processing of FIG. 10 is ended.

As can be understood from FIG. 10, in the sub-scanning correction mode, image unevenness in the main-scanning direction is not measured, and only image unevenness in the sub-scanning direction is newly measured. In a case where the correction has been made in the sub-scanning correction mode, when executing a job after the correction, the image-forming units 10Y to 10K form images under the image-forming condition that has been corrected based on the past measurement result in the main-scanning direction indicated by the first profile data and on the latest measurement result in the sub-scanning direction. When the measurement in the main-scanning direction has not been executed, the first initial profile data indicating the measurement result in the main-scanning direction at the manufacturing stage of the apparatus can be used instead of the first profile data.

### (3) Collective Correction Mode

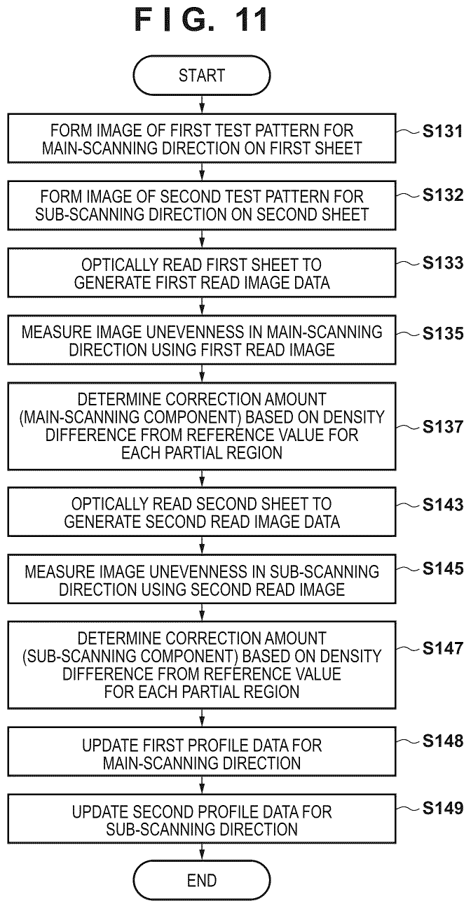

FIG. 11 is a flowchart showing an example of a flow of processing executed by the printer controller 150 in the collective correction mode.

In the collective correction mode, first, the image-forming units 10Y to 10K form the image of the first test pattern generated by the pattern generation circuit 163 on a first sheet in response to an operation on the pattern output button 221 in step S131. Next, in step S132, the image-forming units 10Y to 10K form the image of the second test pattern generated by the pattern generation circuit 163 on a second sheet. At this time, the image-forming units 10Y to 10K perform positioning so that each of the home positions of the angles of rotation of the photosensitive members 1Y to 1K matches the line at which writing of the second test pattern 90 is started.

Next, in step S133, the scanner unit 110 generates a first read image by optically reading the sheet on which the first test pattern has been formed in response to an operation on the read button 222. The scanner controller 115 outputs read image data indicating the first read image to the printer controller 150.

Next, in step S135, the measurement unit 171 measures image unevenness in the main-scanning direction using the first read image. Next, in step S137, the correction unit 172 determines (components in the main-scanning direction of) the correction amounts for the respective partial regions based on the density differences that have been measured using the first read image. Note that although the details are not shown in FIG. 11, steps S135 and S137 can be repeated for each of the four color components.

Next, in step S143, the scanner unit 110 generates a second read image by optically reading the sheet on which the second test pattern has been formed in response to an operation on the read button 223. The scanner controller 115 outputs read image data indicating the second read image to the printer controller 150.

Next, in step S145, the measurement unit 171 measures image unevenness in the sub-scanning direction using the second read image. Next, in step S147, the correction unit 172 determines (components in the sub-scanning direction of) the correction amounts for the respective partial regions based on the density differences that have been measured using the second read image. Note that although the details are not shown in FIG. 11, steps S145 and S147 can be repeated for each of the four color components.

Next, in step S148, the correction unit 172 updates the first profile data stored in the nonvolatile memory 154 so that it reflects the correction amounts determined in step S137. Also, in step S149, the correction unit 172 updates the second profile data stored in the nonvolatile memory 154 so that it reflects the correction amounts determined in step S147. Then, the processing of FIG. 11 is ended.

### (4) Exposure Control Processing

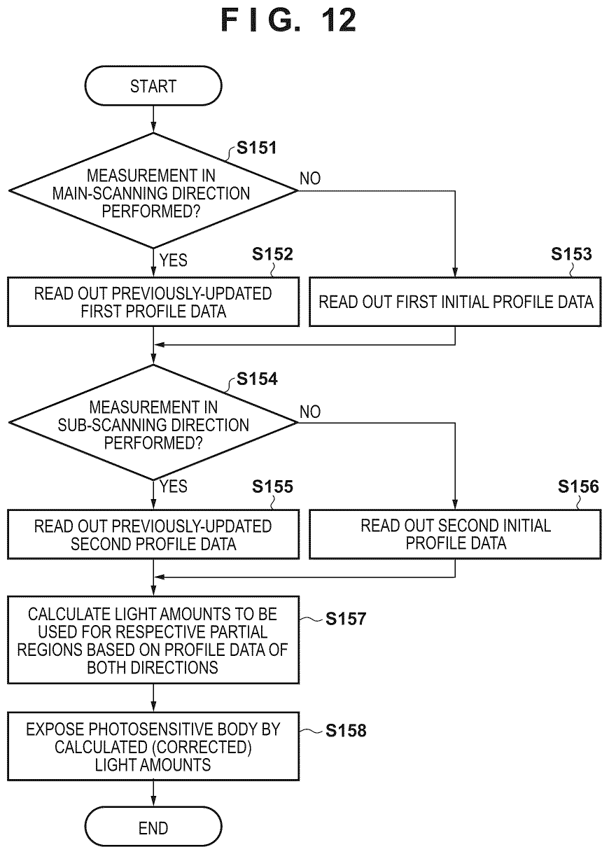

FIG. 12 is a flowchart showing an example of a flow of exposure control processing executed by the printer controller 150 at the time of execution of an image-forming job.

Referring to FIG. 12, first, the processing bifurcates in step S151 depending on whether the measurement in the main-scanning direction has already been executed. In a case where the measurement in the main-scanning direction has already been executed, the correction unit 172 reads out the first profile data that was updated previously from the nonvolatile memory 154 and outputs the same to the light amount control circuit 161 in step S152. In a case where the measurement in the main-scanning direction has not been executed, the correction unit 172 reads out the first initial profile data from the nonvolatile memory 154 and outputs the same to the light amount control circuit 161 in step S153.

Next, the processing bifurcates in step S154 depending on whether the measurement in the sub-scanning direction has already been executed. In a case where the measurement in the sub-scanning direction has already been executed, the correction unit 172 reads out the second profile data that was updated previously from the nonvolatile memory 154 and outputs the same to the light amount control circuit 161 in step S155. In a case where the measurement in the sub-scanning direction has not been executed, the correction unit 172 reads out the second initial profile data from the nonvolatile memory 154 and outputs the same to the light amount control circuit 161 in step S156.

Next, in step S157, the light amount control circuit 161 calculates the light amounts to be used in exposure for the respective partial regions of the image based on the correction amounts in the main-scanning direction indicated by the first (initial) profile data, and on the correction amounts in the sub-scanning direction indicated by the second (initial) profile data. Here, the calculation of the light amounts can be performed as described above using formula (3). Note that although the details are not shown in the figure, the calculation of the light amounts to be used in exposure can be repeated for each partial region during scanning in the main-scanning direction along each line of the image, and scanning in the sub-scanning direction across a plurality of lines.

Next, in step S158, the light amount control circuit 161 controls the exposure devices 3 to expose the photosensitive members 1 to light with the corrected light amounts and form electrostatic latent images corresponding to input image data on the surfaces of the photosensitive members 1 by sequentially issuing instructions indicating the values of the light amounts calculated in step S157 to the PWM modulation circuit 162. Then, after the development of the electrostatic latent images, transferring of toner images, and fixing of the toner images on a sheet, an image is formed on the sheet while suppressing unevenness in density and color in both of the main-scanning direction and the sub-scanning direction.

### <5. Modification Examples>

### (1) First Modification Example

The above embodiment has been described using an example in which image unevenness is measured in both of the main-scanning direction and the sub-scanning direction using the read images of the first test pattern and the second test pattern, respectively. However, a technology according to the present disclosure is not limited to this example. For example, image unevenness may be measured by a potential sensor disposed in each image-forming unit 10 detecting the potential of the photosensitive member 1. The measurement of unevenness using the potential sensor may be applied to any of the main-scanning direction and the sub-scanning direction; in the present section, an example in which image unevenness in the sub-scanning direction is measured using the potential sensor is described as a first modification example.

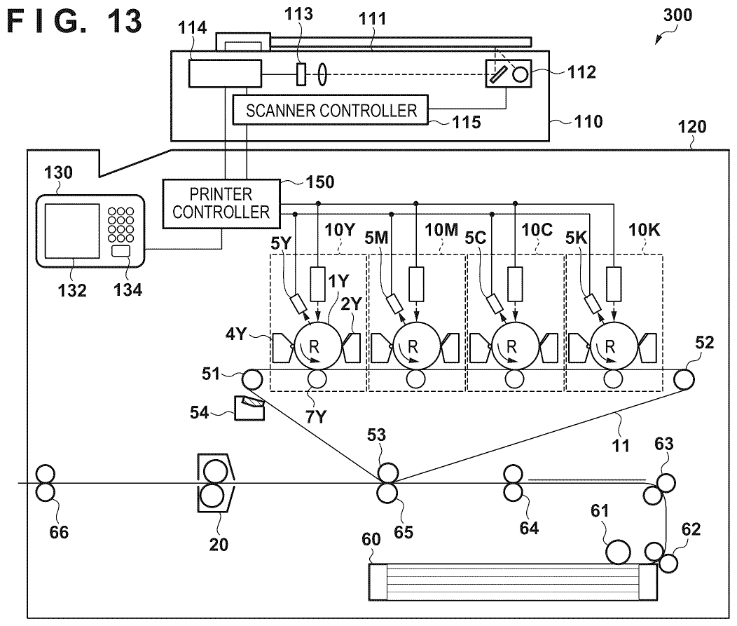

FIG. 13 is a schematic configuration diagram showing an exemplary configuration of an image-forming apparatus 300 according to the first modification example. Referring to FIG. 13, the image-forming apparatus 300 includes a scanner unit 110, a printer unit 120, and an operation unit 130 that are similar to those shown in FIG. 1. However, image-forming units 10Y, 10M, 10C, and 10K of the printer unit 120 include potential sensors 5Y, 5M, 5C, and 5K, respectively. Each potential sensor 5 is a detection unit which is disposed so as to face the surface of the photosensitive member 1 in the same image-forming unit 10, and which detects a test image formed on the photosensitive member 1 by measuring the potential of the charged photosensitive member 1.

In the first modification example, measurement of image unevenness in the main-scanning direction performed by the measurement unit 171 includes measurement of image unevenness in the main-scanning direction using a read image based on optical reading of the first test pattern formed on a sheet, similarly to the above-described embodiment. Meanwhile, measurement of image unevenness in the sub-scanning direction performed by the measurement unit 171 includes detection of the potentials of the photosensitive members 1 on which patterns of latent images for unevenness measurement have been formed, which is performed by the potential sensors 5, and measurement of image unevenness in the sub-scanning direction based on the detected potential distributions on the photosensitive members 1.

In the first modification example, a flow of processing executed by the printer controller 150 in the main-scanning correction mode may be similar to the flow that has been described using FIG. 9.

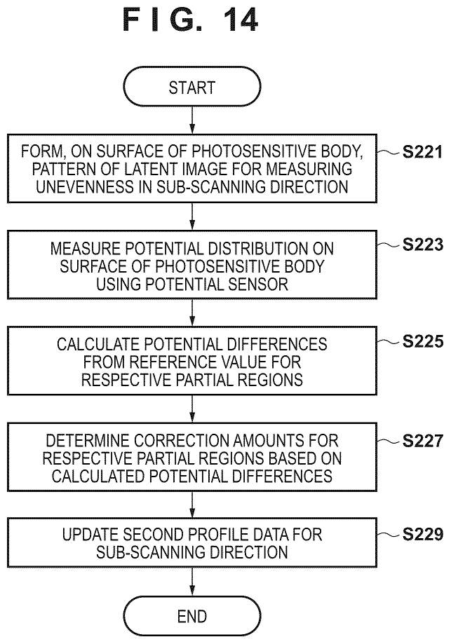

FIG. 14 is a flowchart showing an example of a flow of processing executed by the printer controller 150 in the sub-scanning correction mode.

In the sub-scanning correction mode, first, in response to a GUI operation performed by the user, the measurement unit 171 causes the charger 2 to charge the surface of the photosensitive member 1 at a uniform potential, and causes the exposure device 3 to form a pattern of a latent image for unevenness measurement on the surface of the photosensitive member 1 in step S221. At this time, positioning is performed so that the home position of the angle of rotation of the photosensitive member 1 matches the line at which writing of the pattern of the latent image is started.

Next, in step S223, the measurement unit 171 causes the potential sensor 5 to detect the potential of the photosensitive member 1 while causing the photosensitive member 1 to rotate, and measures the potential distribution in the sub-scanning direction based on sensor data obtained from the potential sensor 5.

Next, in step S225, for each of the plurality of partial regions aligned in the sub-scanning direction, the measurement unit 171 calculates a difference between an average potential and a reference value (e.g., a potential difference) based on the measured potential distribution.

Next, in step S227, the correction unit 172 determines the correction amounts for the respective partial regions based on the potential differences in the respective partial regions calculated by the measurement unit 171. For example, the correction unit 172 can convert the potential differences in the respective partial regions into the correction amounts of light amount using a linear conversion formula or a nonlinear conversion formula that is similar to formula (2) and determined in advance, or a lookup table. Note that although the details are not shown in FIG. 14 for the sake of simple explanation, steps S221 to S227 can be repeated for each of the four color components.

Next, in step S229, the correction unit 172 updates the second profile data stored in the nonvolatile memory 154 so that it reflects the correction amounts determined in step S227. Then, the processing of FIG. 14 is ended.

A flow of processing executed by the printer controller 150 in the collective correction mode may be similar to the flow that has been described using FIG. 11. However, in the present modification example, the formation of the pattern image on the second sheet in step S132 is skipped, and steps S143 to S147 are replaced with steps S221 to S227 of FIG. 14.

Generally, image unevenness in the sub-scanning direction is caused by a variety of factors, such as a wobble in rotation of the image carrier or unevenness in sensitivity thereof, unevenness in resistance of the developer, and unevenness in transfer to the transfer roller. However, normally, unevenness in the potential of the image carrier exerts the largest influence on image unevenness. In view of this, by adopting a configuration that measures unevenness in the potential of the image carrier using the potential sensor as in the present modification example, the cost can be reduced by avoiding consumption of the developing agent, and furthermore, the efficiency of tasks can be increased due to a reduction of the effort in forming an image on a sheet and reading the image.

### (2) Second Modification Example

The above embodiment has been described using an example in which correction of the image-forming condition of the image-forming unit 10 for suppressing image unevenness is made by adjusting the light amount of the exposure devices 3 in both of the main-scanning direction and the sub-scanning direction. However, a technology according to the present disclosure is not limited to this example.

In the second modification example, correction of the image-forming condition for suppressing image unevenness may be made by adjusting at least one of the charging voltage of the chargers 2 and the development voltage of the developers 4. For example, in the main-scanning direction, the light amount of the exposure devices 3 may be adjusted so as to suppress image unevenness, whereas in the sub-scanning direction, the direct-current component of at least one of the charging voltage of the chargers 2 and the development voltage of the developers 4 may be adjusted so as to suppress image unevenness. In other words, the charging voltage or the development voltage is controlled to correct the density unevenness in the sub-scanning direction. In this case, profile data for the sub-scanning direction can indicate correction amounts of the voltage for the respective partial regions, rather than the correction amounts of light amount for the respective partial regions.

### <6. Conclusion>

Thus far, various embodiments and modification examples of a technology according to the present disclosure have been described in detail using FIG. 1 to FIG. 14. According to the above-described embodiment, an image-forming apparatus is provided with:
a first correction mode in which image unevenness is measured in both of a first direction (main-scanning direction) and a second direction (sub-scanning direction), and an image-forming condition is corrected based on the results of these measurements; and
a second correction mode in which image unevenness is measured in one of the first direction and the second direction, and the image-forming condition is corrected based on the result of this measurement.

According to this configuration, whether to measure complex unevenness in two directions with high accuracy in the first correction mode, or promptly measure only unevenness in one direction in the second correction mode, can be selected depending on circumstances. Therefore, an appropriate type of calibration for suppressing image unevenness can be executed, thereby improving efficiency in relation to the execution of a function.

Furthermore, according to the above-described embodiment, the following can be provided as well:
a third correction mode in which image unevenness is measured in the other of the first direction and the second direction, and the image-forming condition is corrected based on the result of this measurement.

According to this configuration, whether to measure complex unevenness in two directions with high accuracy, promptly measure only unevenness in the first direction, or promptly measure only unevenness in the second direction, can be selected depending on circumstances. That is to say, more types of options are provided with regard to calibration for suppressing image unevenness, and an appropriate type can be selected from among these options.

Furthermore, the above-described embodiment can provide a user interface for causing a user to select one of the aforementioned plurality of correction modes. According to this configuration, the user can flexibly select desired balance between the image quality and productivity, which are in a trade-off relationship, in accordance with their needs.

Furthermore, according to the above-described embodiment, in a case where correction is made in the second correction mode, an image can be formed under the image-forming condition that has been corrected based on the latest measurement result in one of the first direction and the second direction, and on the past measurement result in the other direction. According to this configuration, an image with favorable quality can be formed while suppressing unevenness to the fullest in one direction based on the latest measurement result, and also suppressing unevenness sufficiently in the other direction unless there has been a significant fluctuation in unevenness. When the measurement of image unevenness in the other direction has not been executed, unevenness can be suppressed also in the other direction by using data indicating a measurement result that has been obtained at a manufacturing stage before shipping of the apparatus.

Note that the above-described embodiment and modification examples may be used in any combination. For example, the first modification example has been described using an example in which image unevenness is measured using the read image of the test pattern in the first direction, and using the potential sensors in the second direction. However, image unevenness may be measured using the potential sensors in the first direction, and using the read image of the test pattern in the second direction. In a case where image unevenness is measured using the read image of the test pattern formed on a sheet, image unevenness that appears on the sheet under the influence of a combination of various factors can be detected and suppressed comprehensively by way of density measurement. On the other hand, in a case where image unevenness is measured using the potential sensors, consumption of the developing agent can be reduced, and furthermore, the efficiency of tasks can be increased by reducing the user's effort related to handling of sheets.

Furthermore, a part of processing that has been described to be performed at the time of execution of the correction function may be performed at the time of execution of a job. Similarly, a part of processing that has been described to be performed at the time of execution of a job may be performed at the time of execution of the correction function. As one example, at the time of execution of the correction function, the measurement result indicating the density differences or the potential differences for the respective partial regions may be stored as profile data and, at the time of execution of a job, the amount of correction of the image-forming condition may be calculated based on the density difference or the potential difference for each partial region. As another example, at the time of execution of the correction function, addition of the correction amounts (or the density differences or the potential differences) in the main-scanning direction and the sub-scanning direction, or calculation of the light amount for exposure, which is a sum of a reference light amount and a total correction amount, may further be performed, and the result of this calculation may be stored as profile data.

Moreover, though an example in which the second direction is perpendicular to the first direction has been mainly described in this specification, the technology according to the present disclosure is not limited to this example and is broadly applicable to the cases in which the second direction is different from the first direction.

### <7. Other Embodiments>

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-175547, filed on Oct. 10, 2023 which is hereby incorporated by reference herein in its entirety.

What is claimed is:

1. An image-forming apparatus comprising:
image-forming units configured to respectively form images of different colors;
an interface for use in instructing the image-forming units to form a test image; and
a controller configured to:
control the image-forming units to form a first test image including a plurality of image regions of the colors, the first test image being used for correcting density unevenness in a first direction in an image to be formed by the image-forming units; and
control the image-forming units to form a second test image including a plurality of image regions of the colors, the second test image being used for correcting density unevenness in a second direction that is different from the first direction in an image to be formed by the image-forming units,
wherein, in a case where the interface receives an instruction to form both of the first test image and the second test image, the controller is configured to control the image-forming units to form the first test image and then form the second test image.

2. The image-forming apparatus according to claim 1, wherein
each of the plurality of image regions of the colors of the first test image extends in a longitudinal direction that is the first direction, and
each of the plurality of image regions of the colors of the second test image extends in a longitudinal direction that is the second direction.

3. The image-forming apparatus according to claim 1, wherein the interface is configured to receive at least one of:
a first instruction to form the first test image;
a second instruction to form the second test image; and
a third instruction to form both of the first test image and the second test image.

4. The image-forming apparatus according to claim 3,
wherein the interface includes a first button associated with formation of the first test image, a second button associated with formation of the second test image, and a third button associated with formation of both of the first test image and the second test image,
the first instruction is received via an operation of the first button,
the second instruction is received via an operation of the second button, and
the third instruction is received via an operation of the third button.

5. The image-forming apparatus according to claim 3,
wherein the interface includes a first button associated with formation of the first test image, a second button associated with formation of the second test image, and a fourth button for triggering formation of a test image,
the first instruction is received via operations of the first and fourth buttons,
the second instruction is received via operations of the second and fourth buttons, and
the third instruction is received via operations of the first, second and fourth buttons.

6. The image-forming apparatus according to claim 1, wherein each of the image-forming units includes a photosensitive member that is driven to rotate, a light source configured to expose the photosensitive member to light to form an electrostatic latent image, and a developer configured to develop the electrostatic latent image on the photosensitive member, and
the first direction is a direction in which the light from the light source scans the photosensitive member.

7. The image-forming apparatus according to claim 6, wherein the second direction is a direction in which the photosensitive member rotates.

8. The image-forming apparatus according to claim 1, wherein each of the image-forming units includes a photosensitive member that is driven to rotate, a light source configured to expose the photosensitive member to light to form an electrostatic latent image, and a developer configured to develop the electrostatic latent image on the photosensitive member, and
the first direction is a direction that is parallel to a rotation axis around which the photosensitive member rotates.

9. The image-forming apparatus according to claim 8, wherein the second direction is perpendicular to the first direction.

10. The image-forming apparatus according to claim 1, further comprising:
a reading unit configured to read the first test image formed on a sheet.

11. The image-forming apparatus according to claim 10, wherein each of the image-forming units includes an image carrier on which the second test image is formed, and a sensor configured to detect the second test image formed on the image carrier.

12. The image-forming apparatus according to claim 11, wherein the sensor is configured to detect the second test image by measuring a potential of the image carrier.

13. The image-forming apparatus according to claim 1, further comprising:
a reading unit configured to read the first test image formed on a first sheet and to read the second test image formed on a second sheet that is different from the first sheet.

14. The image-forming apparatus according to claim 1, wherein each of the image-forming units includes a photosensitive member that is driven to rotate, a charger configured to charge the photosensitive member, a light source configured to expose the charged photosensitive member to light to form an electrostatic latent image, and a developer configured to develop the electrostatic latent image on the photosensitive member, and
the controller is configured to control an amount of the light from the light source to correct the density unevenness in the first direction and the density unevenness in the second direction.

15. The image-forming apparatus according to claim 1, wherein each of the image-forming units includes a photosensitive member that is driven to rotate, a charger configured to charge the photosensitive member, a light source configured to expose the charged photosensitive member to light to form an electrostatic latent image, and a developer configured to develop the electrostatic latent image on the photosensitive member, and
the controller is configured to:
control an amount of the light from the light source to correct the density unevenness in the first direction; and
control a charging voltage of the charger to correct the density unevenness in the second direction.

16. The image-forming apparatus according to claim 1, wherein each of the image-forming units includes a photosensitive member that is driven to rotate, a charger configured to charge the photosensitive member, a light source configured to expose the charged photosensitive member to light to form an electrostatic latent image, and a developer configured to develop the electrostatic latent image on the photosensitive member, and
the controller is configured to:
control an amount of the light from the light source to correct the density unevenness in the first direction; and
control a developing voltage of the developer to correct the density unevenness in the second direction.
